(19) United States
(12) Patent Application Publication
(10) Pub. No.: US 2019/0132629 A1
(43) Pub. Date: May 2, 2019

(54) APPLICATION FOR DETECTING A CURRENCY AND PRESENTING ASSOCIATED CONTENT ON AN ENTERTAINMENT DEVICE

(71) Applicant: JONATHAN KENDRICK, Culver City, CA (US)

(72) Inventor: JONATHAN KENDRICK, Culver City, CA (US)

(21) Appl. No.: 16/172,423

(22) Filed: Oct. 26, 2018

Related U.S. Application Data
(60) Provisional application No. 62/577,609, filed on Oct. 26, 2017.

(51) Int. Cl. H04N 21/2668; G06F 17/30; H04N 21/258; H04N 21/442; G06Q 30/02; G06K 9/00; G07D 7/00

(52) U.S. Cl. CPC H04N 21/2668; G06F 17/30952; H04N 21/25883; G07D 7/00; G06Q 30/0201; G06K 9/00442; G06F 17/30038; H04N 21/44222

(57) ABSTRACT

A method performed by a processor in an entertainment device that is executing an application program that provides content of artists. The method performs a digital image processing currency recognition algorithm upon an image that has been captured by a camera in the device, to indicate a detected currency, where the algorithm is configured to detect several different currencies from digital images of coinage or paper money of the different currencies. The method performs a table lookup using the detected currency, into a data structure stored in the device. The data structure associates the different currencies with several descriptions of content, respectively, where each content is distributed through a country from which the associated currency is issued. Upon selecting one of the descriptions of content, the method requests that a notification that refers to the selected description be presented for display through a touch screen of the device.

### CROSS REFERENCE TO RELATED APPLICATION

This application claims priority to U.S. Provisional Application No. 62/577,609 filed on Oct. 26, 2017, herein incorporated by reference in its entirety.

### FIELD

An embodiment of the invention relates to an application running on an entertainment device that performs a currency recognition algorithm to detect currency of a country in an image, and, in response, presents a user a description of content associated with the country.

### BACKGROUND

With the proliferation of entertainment devices (e.g., tablet computer) that are capable of connecting to the Internet, users of those devices have an endless selection of audio-visual works that can be delivered to their devices. Although some content may be free, the majority of licensed content must be purchased through an on-line vender. Once purchased, the user may enjoy the licensed content through the entertainment device in which the content was purchased.

### SUMMARY

An embodiment of the invention is an application that runs on an entertainment device (e.g., tablet, smartphone, or desktop computer) that is capable of presenting a user of the entertainment device descriptions of content (e.g., any type of audio-visual content, such as music, movies, or games) of artists (e.g., singers, actors, painters, or writers), where the content are associated with several countries, through currency recognition. The application, which may be provided free to the user, can be downloaded from a server of a service provider over the Internet and installed into the entertainment device. Once the application is launched in the entertainment device, the user may “aim” the device's built-in digital camera at currency (e.g., coinage or paper money) that the user recognizes as being issued by a particular country or a government body of the particular country. The camera will then capture an image of the currency, and in response, automatically (without further user input required), the application then performs a digital image processing currency recognition algorithm that is configured to detect different currencies from images of coinage or paper money within the image. For instance, to detect the currency in the image, the currency recognition algorithm may analyze the captured image to recognize patterns therein (e.g., structural patterns), and compare them to previously stored patterns of different currencies stored in the device. Once a matching pattern is found, the application is said to have detected the currency in the image. Using the detected currency, the application checks a lookup table, stored in the device, that associates different currencies with descriptions of content, respectively. Each content described in the descriptions may be associated with a country by being distributed through the country from which the associated currency is issued. Upon making a selection of one of the descriptions of content, the application may request that a notification which refers to the selected description be presented for display through a touch screen of the device (e.g., showing a prompt on the touch screen). The user may access the described content by making a selection of the notification on the touchscreen. If, in order to access the content, the user is required to pay for the content, the application may prompt the user to purchase the content. Once purchased by the user, the application may receive (e.g., from a service provider) the content and/or an encryption key for use to gain access to the content. Otherwise, if the user already has access (e.g., either by previously purchasing the content or the user is not required to purchase the content), the application may allow the user to gain access (e.g., playback the content), immediately thereafter. Thus, the application allows a user to retrieve content distributed through a particular country (e.g., the United States), by taking a picture of the particular country's currency (e.g., a United States one-dollar bill), which may be widely known to be associated with that country and readily available to the user (e.g., in the user's wallet while the user is within the country.) The content may be, for example, specially licensed audio-visual content depicting an artist, such as Beyoncé, backstage at one of her concerts, which has been exclusively licensed (e.g., by Beyoncé) to the provider of the application for distribution through the United States. Thus, when the picture is of United States currency, the selected description may be that of the specially licensed audio-visual content depicting Beyoncé.

Content may be retrieved locally or from a remote server (e.g., via the Internet). If the content is stored in memory locally, it may be encrypted, in order to secure the content from unauthorized access (e.g., by hackers.) To gain access to the encrypted content, the user may be required to purchase the content and/or a license to the content from the service provider. Subsequently, the service provider may transmit an encryption key to the device to decrypt the encrypted content, in order to allow the user to gain access. In addition, the described content may be stored in memory of the device, either at the time in which the application is downloaded and installed into the device, or it may be previously retrieved from the remote server by the application. In this way, content and the descriptions of the content may be periodically updated within the memory of the device by the application, so as to ensure that available content for purchase is the most recent content distributed through or within countries (e.g., by artists.) For instance, either new content may be retrieved, or currently existing content within the device may be updated (e.g., a newer version). Conversely, content currently existing within the device may also be removed (e.g., limited time offer). Thus, once a user purchases the content, the application may present the purchased content immediately, without delay that may be a result of downloading the content from a remote server. If, however, the content is stored remotely (e.g., at a remote server), the application may retrieve (e.g., download) the content from the remote server, and present the content to the user.

Retrieved encryption keys may be temporarily stored in memory (e.g., within the application), so as to prevent hackers from gaining unauthorized access to the encryption keys (e.g., by gaining administrator/root access to the device). In other words, encryption keys may only be stored within the device, while the application is executing and/or while the device remains active. Otherwise, when the application is closed or the device is turned off, the encryption keys may be erased from memory. To ensure that access to purchased content is not obstructed, the encryption keys may be retrieved (e.g., via a secure connection) with the service provider, each time the application is launched on the device.

Since the application is performing the currency recognition locally or within the entertainment device, any delay associated with accessing a currency and/or image pattern recognizer that might otherwise be running on a remote server on the Internet is avoided. Moreover, any delay associated with accessing a decision maker that might otherwise be running on the remote server, which makes a decision as to which description of content should be presented in response to detecting a currency in a captured image, is also avoided, thereby making the presentation to the user, of the description of content, essentially immediately after the user has aimed the device at the currency.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, in the interest of conciseness and reducing the total number of figures, a given figure may be used to illustrate the features of more than one embodiment of the invention, and not all elements in the figure may be required for a given embodiment.

FIG. 1 is a block diagram of one embodiment of a system that retrieves content associated with a country in response to a user purchasing the content, when a currency recognizer in an entertainment device detects currency issued by the country that is in an image captured by the entertainment device.

FIG. 2 is a flowchart of one embodiment of a process of presenting a user with a description of content that is associated with a country from which a detected currency is issued.

FIG. 3 is a flowchart of one embodiment of a process of receiving encryption keys for use in gaining access to purchased content.

FIG. 4 is a flowchart of one embodiment of a process of accessing content.

FIG. 5 is a block diagram of an entertainment device.

### DETAILED DESCRIPTION

Several embodiments of the invention with reference to the appended drawings are now explained. Whenever the shapes, relative positions and other aspects of the parts described in the embodiments are not explicitly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

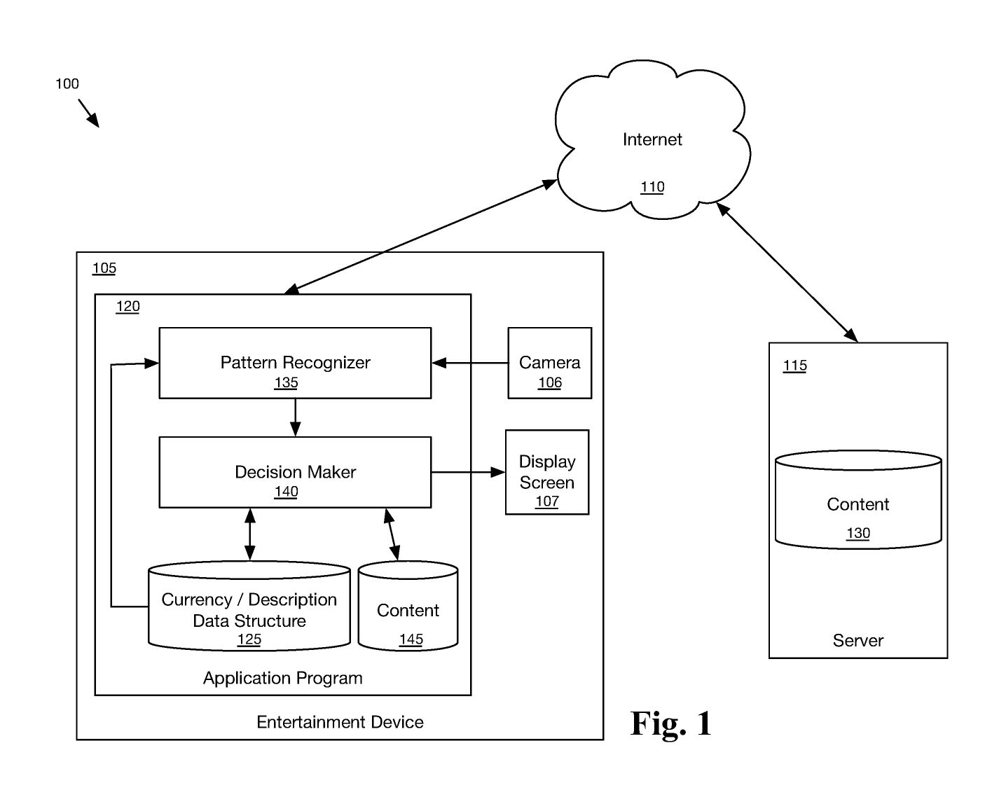

FIG. 1 is a block diagram of one embodiment of a system 100 that allows access to content associated with a country, in response to a user purchasing the content, when a currency in an image captured by a camera of an entertainment device issued by the country is detected. The system 100 includes an entertainment device 105, the Internet 110, and a server 115.

The entertainment device 105 may be any sort of electronic device that is capable of storing and executing an application (e.g., software program), capturing an image using a digital camera (e.g., built-in or external), and connecting (e.g., wirelessly) to a server over the Internet (e.g., a tablet computer, desktop computer, or smartphone). In an aspect, the entertainment device 105 can comprise a smartphone. The entertainment device 105 can be configured to communicate via one or more of second generation (2G), third generation (3G), fourth generation (4G), fifth generation (5G), GPRS, EDGE, D2D, M2M, long term evolution (LTE), long term evolution advanced (LTE-A), code division multiple access (CDMA), wideband code division multiple access (WCDMA), universal mobile telecommunications system (UMTS), wireless broadband (WiBro), Voice Over IP (VoIP), and global system for mobile communication (GSM). The entertainment device 105 can further be configured for communication over a local area network connection through network access points using technologies such as IEEE 802.11.

The entertainment device 105 can further be configured for communication over Bluetooth and/or near field communications (NFC). The entertainment device 105 can comprise a GPS receiver that can receive position information from a constellation of satellites operated by the U.S. Department of Defense. Alternately, the GPS receiver can be a GLONASS receiver operated by the Russian Federation Ministry of Defense, or any other positioning device capable of providing accurate location information (for example, LORAN, inertial navigation, and the like). The GPS receiver can contain additional logic, either software, hardware or both to receive the Wide Area Augmentation System (WAAS) signals, operated by the Federal Aviation Administration, to correct dithering errors and provide the most accurate location possible.

The entertainment device 105 can comprise a camera or other image sensor configured to capture both still and moving images (e.g., of currency). The camera may capture images within the visible spectrum portion of the electromagnetic spectrum that is visible to the human eye. The camera may also capture images outside the visible spectrum portion of the electromagnetic spectrum including infrared and ultraviolet. The camera may be of a complementary metal oxide semiconductor (CMOS) type or a semiconductor charge coupled device (CCD) type and may include an image focusing lens and an image zoom function. The entertainment device 105 can have installed thereon an application 120 configured for enabling a user of the entertainment device 105 to capture images of currency and receive related content.

The entertainment device 105 may comprise a digital camera 106, a display screen 107 (e.g., touch screen), and an application 120 that is stored in memory of the device 105 and that, in one embodiment, is for retrieving content of artists (e.g., singers, actors, painters, writers, performers e.g., comedians, or a group of several such persons acting under a common name e.g., a musical band or actors in a television show series). In another embodiment, the application may retrieve content of companies (e.g., retailers), locations (e.g., public parks, an amusement parks, a national monuments, or any place of business), or a group of things (e.g., music, movies, and television shows).

The application 120 is for presenting the user of the device with a notification that refers to a description of content, where the described content is associated with a country that issued a currency detected in a captured image. For example, the user may aim the (e.g., built-in) camera 106 at a currency (e.g., coinage or paper money) issued by a country, or rather, a government body of the country. In one embodiment, the user may aim the camera at a currency that is issued by a country at which the user is currently located (e.g., because the user is vacationing in the country). For example, if the user is vacationing in the United States (e.g., from Mexico), the user may aim the camera 106 at a United States quarter dollar (i.e., coinage) or at a United States one-dollar bill (i.e., paper currency). The camera may capture an image of the currency, and the application may detect the currency at which the user has aimed the camera 106 as a result of processing the captured image through a digital image processing currency recognition algorithm. Specifically, the algorithm processes the image to identify a structural pattern of the currency and/or a portion of the currency in the image captured by the camera matches a predefined structural pattern of the currency stored in the device. When the matching predefined structural pattern is found, the application is said to have detected the currency within the image. In response to detecting the currency, the application may perform a table lookup into a data structure 125 that associates different currencies with descriptions of content, respectively. Each content may be associated with a country from which the associated currency is issued, by being distributed through or within the particular country. Upon selecting one of the descriptions of content that is distributed through the country that issued the detected currency, the application may present the user with a notification (e.g., by displaying it on a touch screen of the device) that refers to the selected description. As a result, the user may then select the notification (e.g., through a tap gesture on a touch screen of the device) to access the described (e.g., specially licensed) content. If the user is required to purchase the content in order to gain access, the application 120 may prompt the user to purchase the content. Otherwise, if the user already has access (e.g., because the user has previously purchased the content or is not required to purchase the content because it is free), the application may allow the user to gain access (e.g., playback the content, if it is audio-visual content). In this way, continuing with the previous example, if the currency in the captured image is issued by the United States Government (e.g., a United States one-dollar bill), the content descriptions presented to the user would be those distributed through (or within) the United States (e.g., content providers of the content have licensed the content to distributors and/or to a service provider of the application for distribution through the United States). Thus, a user vacationing (e.g., from Mexico) in the United States, who wishes to purchase content distributed through the United States (e.g., because the user wishes to view content being in English), may be presented with descriptions of such content, in response to capturing images of United States currency. If, on the other hand, the user wishes to purchase content associated with Mexico (e.g., being distributed in Mexico), the user may capture an image of a Mexican peso (e.g., any particular denomination of the Mexican peso), and as a result, be presented with descriptions of content that are different than content being distributed in the United States. For example, in one embodiment, the content may be different (e.g., associated with different artists), while in another embodiment, the content may be the same, but being different versions of the same content being distributed in the different countries (e.g., content in English distributed in the United States, while the same content in Spanish is only distributed in Mexico.) In another embodiment, one country may distribute several versions of a piece of content (e.g., the United States may distribute an English and Spanish version of content.) In one embodiment, the described content (e.g., first description) presented to the user in response to capturing an image of a United States dollar bill, may be different than described content (e.g., second description) presented to the user in response to capturing an image of a Mexican peso.

The application 120 includes a currency and/or pattern/currency recognizer 135, a decision maker 140, a data structure 125 in which several different currencies that are associated with descriptions of content that are associated with different countries from which the different currencies are issued, respectively, for example as a lookup table (e.g., stored in memory), and optional content 145 (e.g., specially licensed content) that may be purchased by the user. The application 120 can utilize the entertainment device's 105 camera to scan an item of currency (e.g., capture a temporary image of the currency in order to process it using optical character recognition or the like) or, alternatively, take a picture/image of the currency (e.g., capture an image of the currency and storing it in memory of the entertainment device 105). The application 120 (e.g., the pattern/currency recognizer 135) can extract an object the image and determine if the extracted object is a currency symbol (e.g., $, €, £, ¥, etc.) or other identifying characteristic associated with a given type of currency (e.g., an image of George Washington would correspond to U.S. currency, while an image of Queen Elizabeth would correspond to British currency). Alternatively, the application can transmit/upload the image to the server 115, which may can extract an object from the image and determine if the extracted object is a good and determine if the extracted object is a currency symbol or other identifying characteristic associated with a given type of currency.

Each of the different currencies within the data structure 125 may be associated with a predefined structural pattern (e.g., an object, such as a currency symbol, depicted on a given type of currency) of a particular currency issued by a particular country and/or government body of the particular country. For example, a United States one-dollar bill may be associated with one predefined structural pattern, while a United States five-dollar bill may be associated with another predefined structural pattern. In one embodiment, several different (e.g., denominations of) currencies issued by a country may be associated with one or more predefined structural patterns. The predefined structural patterns may have been previously generated by a service provider of the application and stored within the data structure 125. Associated with each of the different currencies is a description of content that is associated with the country from which the different currency was issued. As will be described later, the content may be associated with the country, by the content being distributed through that country. For example, a predefined structural pattern of the United States one-dollar bill may be associated with a description of audio-visual content of Beyoncé, because she has licensed the content (e.g., to the service provider of the application or a third-party distributor) for distribution through (or within) the United States. In one embodiment, when a currency is associated with several descriptions of content, the decision maker 140 may determine which (if any) descriptions are presented to the user. In another embodiment, descriptions of the content may refer to several versions of content. For example, since content (e.g., movies) may be distributed in countries with a diverse population, speaking different languages, distributors and/or content providers may create several versions of the same content (e.g., in different languages). Thus, when the description of content refers to several versions of content, a selection of a particular version to be associated with the description may be made the decision maker 140, based on user input (e.g., based on a preferred language setting on a user device). In another embodiment, the decision maker 140 may present descriptions of the content for all versions (e.g., all available languages) of the content to the user. More about the decision maker 140 is described below.

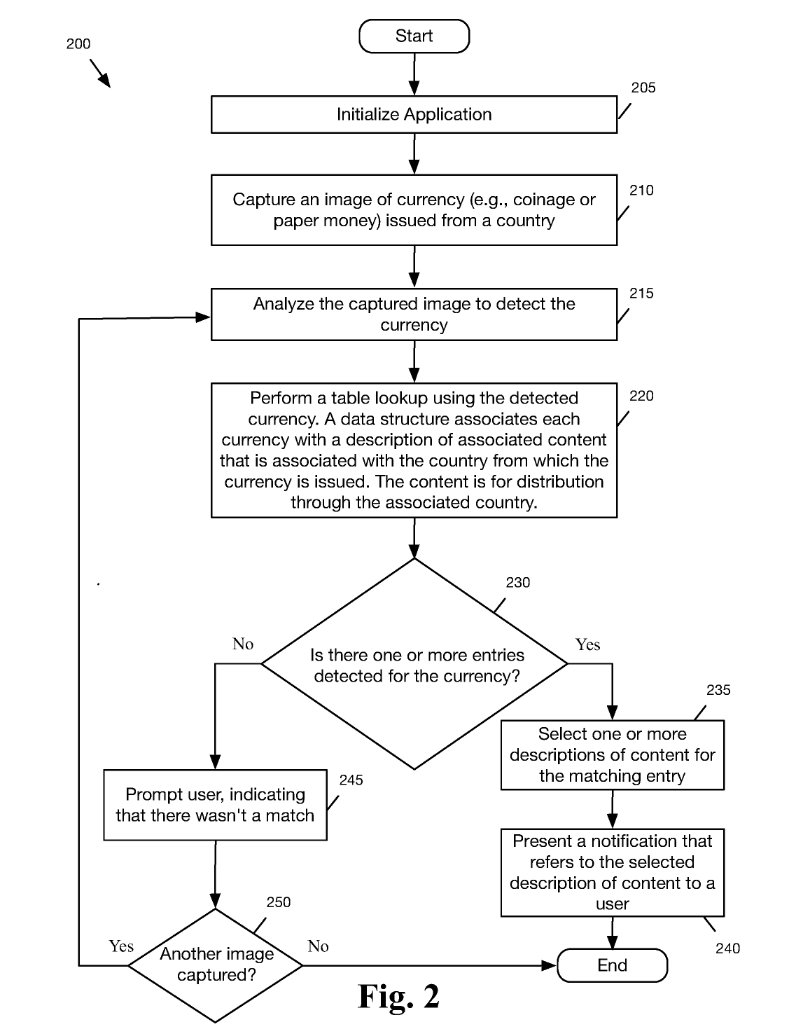

Each of the associated descriptions within the data structure 125 may include a description of the content (e.g., a thumbnail image and text) for display, such as on the display screen 107, in response to the notification being presented to the user. For example, the description may describe the content. In one embodiment, the presented notification may include a short introductory video (e.g., advertisement or promotion) relating to the content that is to be displayed on the display screen 107, prior to display of the description of the content (e.g., for purchase by the user.) In one embodiment, the data structure 125 may include additional descriptive information about the content that is not otherwise presented to the user. For example, the additional descriptive information may be used to determine whether the notification referring to the description of the content should be presented (e.g., key words relating to the content). In another embodiment, the additional descriptive information may also include a code and/or content identifier, which identifies the described content and is transmitted to a third-party provider or the service provider of the application (e.g., a remote server) for retrieving the content, when the user requests to purchase the content. In the same way, the code or content identifier may be used by the decision maker 140 to retrieve the content from the optional content storage 145, when it is stored locally. More about purchasing content is further described in FIG. 2.

The pattern/currency recognizer 135 executes a digital image processing currency recognition algorithm to detect a currency (e.g., by recognizing objects, such as currency symbols and/or photographs, depicted) in a captured image. The user can capture and store (e.g., in memory) one or more images of currency, including 2D and/or 3D image files of the currency. Any 2D image file can be used including, but not limited to, Portable Document Format (.PDF), JPEG (.JPG) format, Portable Network Graphics (.PNG) format, Adobe® Photoshop® (.PSD) format, and the like. Any 3D image file can be used including, but not limited to, STL, OBJ, FBX, COLLADA, 3DS, IGES; STEP, and VRML/X3D. The 3D image file store information about 3D models of a good as plain text or binary data. In particular, the 3D image file encodes at least the 3D model's geometry and/or appearance. The geometry of a model describes its shape. The appearance of a model includes, for example, colors, textures, material type, and the like. The 2D and/or 3D image files of the good can be provided to the pattern/currency recognizer 135 for later processing. For instance, the pattern/currency recognizer 135 may receive the digital image of the currency captured by the camera 106 of the entertainment device 105, and process the digital image to identify a structural pattern (e.g., an object, such as a currency symbol, depicted on a given type of currency) within the image. The pattern/currency recognizer 135 may retrieve predefined structural patterns that are associated with different currencies from the data structure 125 to determine which of the predefined patterns matches the identified structural pattern. Once a match is found, the pattern/currency recognizer 135 may transmit data to the decision maker 140, indicating the detected currency in the digital image that is associated with the matching predefined pattern.

The decision maker 140 is for deciding which description(s) of content that are associated with a country of the detected currency should be presented to the user on the display screen 107 of the entertainment device 105. Specifically, the decision maker 140 will perform a table lookup using the detected currency into the data structure 125, to determine whether there are matching descriptions of content (e.g., entries in the lookup table) that are associated with the country that issued the detected currency. Or in other words, the decision maker 140 will determine whether there are any descriptions of content that are associated with the detected currency. If there is a matching description, the decision maker 140 may select it and present a notification referring to the selected description on the display screen 107 of the entertainment device 105. In one embodiment, the decision maker 140 may select any and all of the matching descriptions for presentation. As a result, each of the descriptions of content may be presented in a separate notification within a scrollable list, displayed on the display screen 107 of the device 105. As will be described later, the user may select one of the notifications in order to gain access to the content described therein.

In one embodiment the content is associated with the country of the detected currency by being distributed through (or within) the country. For example, the content may be specially licensed audio-visual content depicting an artist, such as Beyoncé backstage at one of her concerts. The rights (e.g., copyright rights) to distribute the content may be owned by Beyoncé (or a content provider), and licensed to the service provider of the application program 120. In other words, the content may be specially licensed and/or authorized content to a provider of the application 120. Thus, continuing with the example, if the content is licensed by the service provider of the application program 120 for distribution within the United States, when the detected currency is of United States currency (e.g., the United States one-dollar bill), the decision maker 140 may select that content for presentation to the user. In one embodiment, the service provider may license the content from a third-party distributor, while in another embodiment the service provider may own (e.g., the distribution rights of) the content.

In one embodiment the decision maker 140 may narrow down and/or avoid potential descriptions of content that are associated with the country that issued the detected currency for selection, based on additional data stored within memory of the entertainment device 105. In other words, rather than present all descriptions of content that are associated with the country of the detected currency, the decision maker 140 may only present a subset of the descriptions, based on certain criteria. For instance, the decision logic 140 may avoid certain potential descriptions based on user settings of the entertainment device, such as parental controls that restrict certain content from being viewed (e.g., explicit content and/or types of content may be blocked). As previously described, the data structure 125 may include additional descriptive information about the content. The decision maker 140 may retrieve the additional descriptive information about the content, and use this information to narrow down potential descriptions of content for selection. For example, the descriptive information may indicate that one of the content is not intended for young children (e.g., has a Motion Picture Association of America (MPAA) rating of “R”), or that the content includes inappropriate language. The decision maker 140 may then use the additional descriptive information to avoid certain potential descriptions of content that would otherwise be restricted by the parental controls of the entertainment device. In another embodiment, the decision maker 140 may look at purchase history (e.g., types of previous content purchased, and already purchased content) by the user. For example, if the user has purchased (e.g., through the application 120) several specially licensed pieces of content of a particular artist (e.g., Beyoncé), the decision maker 140 may decide to present the notification with a description of content of Beyoncé. In another embodiment, rather than narrow down potential descriptions of content, the decision maker 140 may arrange the presented descriptions in a particular order (e.g., most likely to be purchased by the user), based on the criteria.

In one embodiment, the decision maker 140 may decide which description of content should be presented to the user on the display screen 107 of the entertainment device 105, based on a theme (e.g., music genre, movie genre, art styles, or book genre) of the content or type of content (e.g., musical compositions or audio-visual works) the user wishes to receive. In another embodiment, the decision maker 140 may decide based on a type of artist (e.g., singers, actors, painters, writers, or performers) that is associated with the content. In yet another embodiment, the decision maker 140 may decide based on the artist, who is associated with the content (e.g., created and/or performed the content), being also associated with the country from which the detected currency was issued. In one embodiment, an artist may be associated with a country by one of i) the artist being from the country, ii) the artist currently residing in the country, iii) the artist having created the content within the country, iv) the artist (or a content provider, with the artist's permission) is selling the content exclusively (e.g., only) within the country, or v) the artist having created the content in a same language as is (e.g., primarily or universally accepted to be) spoken by citizens of the country (e.g., if the country is the United States, the language would be English). In one embodiment, the decision as to what type/theme of content and/or artists to receive content is chosen by the user (e.g., set in a settings menu of the application). For example, if a user wishes to only receive notifications of purchasable content of jazz singers (or performers), the user will instruct the application (through settings) to narrow down any potential descriptions of content to those that are of jazz singers that are associated with a country that issued a detected currency. In another embodiment, the application is a themed application, which is predetermined (e.g., by the service provider prior to being downloaded) to retrieve certain content of artists based on its theme (e.g., jazz).

Once an appropriate description of content is chosen, the decision maker 140 retrieves the description of the content from the data structure 125 and presents a notification that refers to the description on the display screen 107 of the entertainment device for the user to access (e.g., and possibly purchase) the content (e.g., by selecting the notification). The content described in the presented notification may be specially licensed and/or authorized content to a provider of the application. For example, when the application is associated with artists (e.g., singers), the content may be specially licensed content by the artists to the provider of the application. The specially licensed content may be musical compositions (e.g., songs) performed by or relating to the artists. The specially licensed content may also include any other type of audio-visual work (e.g., a movie or a music video). The specially licensed content may also be content that is not readily available through media outlets or other service providers. In other words, the specially licensed content, which may be licensed and/or authorized by the artists for distribution, may not be “mainstream content” like songs that are played on the radio or music videos that are played on television and/or streamed over the Internet. Instead, the specially licensed content may be less well-known works and/or “behind the scenes” content. For example, the less well-known works may be unpublished works (e.g., songs) that had not previously been licensed and/or authorized by the artists for distribution to the public-at-large for purchase.

Along with being specially licensed, the content may be any type of licensed and/or authorized (e.g., mainstream) content to the provider of the application. For example, when the application is associated with the certain artists (e.g., singers), the content may include digital albums/songs released by the singers associated with the country that issued a detected currency. In one embodiment, rather than being audio-visual content, the purchasable content may be physical products, such as merchandise or memorabilia (e.g., t-shirts, posters, stickers, etc.) that are distributed and/or sold through or within the country that issued the content. In the case in which the purchasable content are tangible products (e.g., merchandise, memorabilia, clothes, tools, and electronics), once a user purchases the products (e.g., through a selection of the notification), the user may be prompted to enter and/or confirm a mailing address where a distributor will mail the products. In one embodiment, once purchased, no other user interaction is necessary, since user information needed to make a purchase (e.g., credit card information and mailing address) are already known to the provider. To obtain the application, the user of the device 105 may download the application 120 from a service provider (e.g., third-party) for free. Once downloaded, the application 120 may be installed into memory of the device 105 and the user of the device 105 may register, through the application, with the service provider using information that is specific to the user (e.g., providing a user email address and a mailing address). Once registered, the device 105 may receive an application identifier that is unique to the device 105, which as will be described later, may be used to retrieve encryption keys to access content stored in the entertainment device 105. In one embodiment, the user may provide payment information (e.g., a credit card number) to the service provider, which will use this information to retrieve payment when the user purchases the content through the application (e.g., by selecting a presented notification). In another embodiment, the user may link an account with a third-party provider payment service to the application when it is downloaded. In this way, once the user selects a notification to purchase described content, the service provider may receive payment from the payment service. The server 115 may be a server of the service provider, in which the application 105 was downloaded. In one embodiment, the server 115 may be of any service provider that distributes (e.g., sells or licenses) the content in which the user of the entertainment device 105 purchases. In the server 115 is a storage of content 130 (e.g., specially licensed content that is textual, graphical, musical, or audio-visual licensed works of artists.) In one embodiment, once the service provider has confirmed (e.g., received payment) the purchase of the content by the user at the entertainment device 105, the server 115 may retrieve the purchased content from the storage 130 and forward the content (e.g., through the Internet 110) to the entertainment device 105 for presentation by the application 120. In one embodiment, if the content is a tangible product (e.g., merchandise of the artist), the server 115 may instead transmit a sales confirmation to a distributor, in order for the distributor to mail the product to a mailing address of the user.

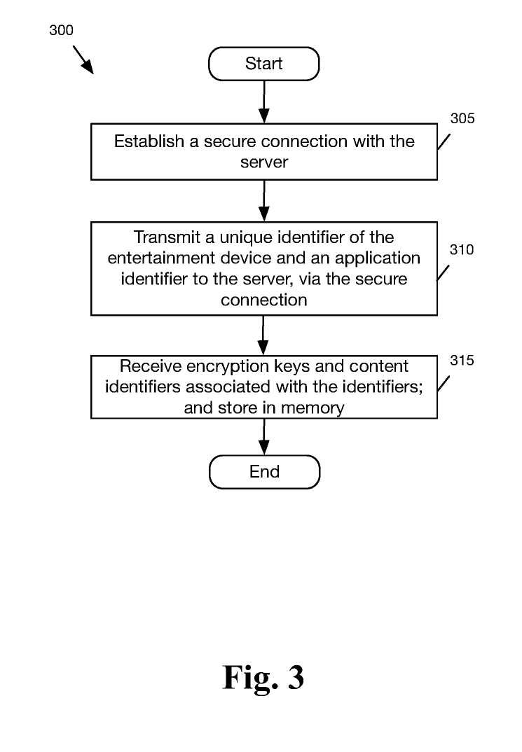

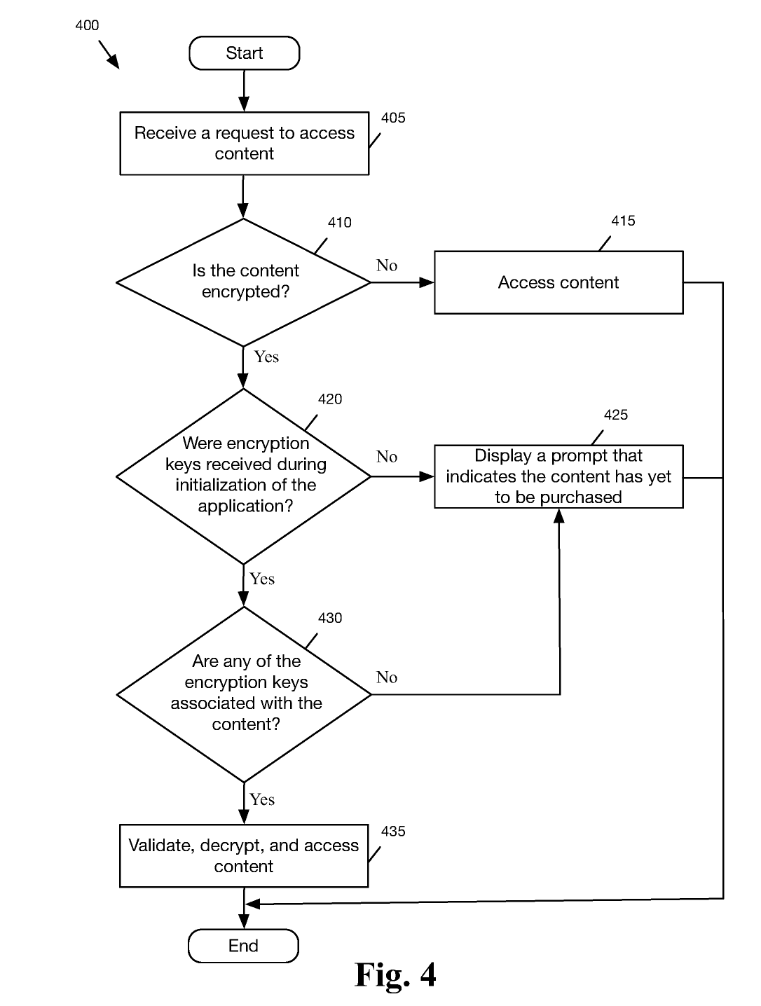

In one embodiment, rather than retrieving the content from the server 115, the content (e.g., specially licensed content) may already be stored within optional content 145 within the application 120. Content stored within the optional content storage 145 may be compressed (e.g., if audio-visual content, such as a movie, the content may be compressed using any conventional video codec, such as H.264 or MPEG-4), in order to minimize required storage space in memory. In addition, the content may either be encrypted or unencrypted, depending on whether the user is required to purchase the content before gaining access. For example, if the content described in the notification is unencrypted, thereby allowing anyone who is running the application 120 to access the content, the decision maker 140 may retrieve the content described in the selected description from the optional content 145 stored within the entertainment device and present the content on the touch screen of the device. In another embodiment, however, the content within the optional content 145 may be encrypted. For example, the content may be either partially, or completely encrypted with an encryption key by the service provider, before the content was received at the entertainment device (e.g., having been downloaded along with the application 120, or subsequently downloaded, as later described.) In this case, when the user requests to access the content, the user may be prompted to purchase the encrypted content (e.g., through a selection of the notification.) In response, the application 120 may transmit a confirmation of the purchase, a unique identifier of the entertainment device 105, and/or an application identifier to the server 115. Once received, the server 115 may confirm the purchase (e.g., based on the confirmation) and associate a content identifier of the purchased content to the entertainment device (e.g., based on the unique identifier and the application identifier). The server 115 may then transmit an encryption key and the content identifier to the application 120 (e.g., through the Internet 110). The application 120 may first validate the purchased content using the content identifier, and if validated, then access the encrypted content through the use of the received encrypted key. More about retrieving encryption keys and accessing content is described in FIGS. 3-4.

In one embodiment, the service provider may periodically update data stored within the application 120 (e.g., data structure 125 and/or content storage 145). This may be due to the fact that 1) artists are continuously creating new content and/or updating currently existing content, and/or 2) content providers are continuously licensing new content for distribution and/or removing licenses from currently existing content. Once new and/or different content is available, the service provider may then associate a description of the new content with a currency, based on the content's association with a country that issued the currency (e.g., the content being distributed through the country). In one embodiment, the service provider may associate the new content with a currency that is already associated with other content. In one embodiment, the new content may be a different version of another content (e.g., a different language) that is already associated with the currency. The service provider may then compress the content (e.g., in the case of audio-visual content, the service provider may compress the content using any convention video codec, e.g., H.264 or MPEG-4), and then optionally encrypt the compressed content with an encryption key. The service provider may then transmit the data through the Internet 110 and to the entertainment device 105 in order to update the data structure 125. Once the entertainment device receives the data, the descriptions of the new content are added to the data structure 125 and the new (e.g., encrypted) content is added to the content storage 145. In one embodiment, the data from the service provider may also indicate which of the different currencies the descriptions of new content are to be associated. In one embodiment, this process may be automatic and without user intervention. For example, since content (even compressed content) may have a significant file size, the application may only update under certain conditions. For example, the application 120 may be updated while 1) the entertainment device is plugged into an electrical outlet (e.g., in order to not drain the battery), and 2) the entertainment device is connected to a wireless communications network (e.g., a Wi-Fi-network.) Conversely, the service provider may instruct the application to remove content currently existing within the device (e.g., the content being a limited time offer.). In this case, the service provider would signal the application 120 to erase the content from memory of the device 105.

In addition to the embodiments discussed above, the pattern/currency recognizer 135 may determine a structural pattern (e.g., an object, such as a currency symbol, depicted on a given type of currency) within a captured image of currency by providing the image received from the entertainment device 105 to an object recognition engine. The object recognition engine can be trained against a library of labeled images. The object recognition engine can comprise an image search tool (e.g., Google® Image Search) and/or a search engine/cognitive service (e.g., Amazon Rekognition, Clarifai, Microsoft Azure Cognitive Services, Google Image Intelligence, Bing®, IBM Watson®, etc.) for analysis. The object recognition engine can analyze the image received from the entertainment device 105 by applying computer vision and/or image analysis algorithms to detect the presence of specific persons, objects, brands, logos, text, etc. within the image. If no known objects are found or a known object is found that does not relate to any known currency, the entertainment device 105 may provide feedback to the user that no known currency has been identified (e.g., via a pop-up notification).

In an aspect, some or all of the functions of the object recognition subsystem described herein can be performed by a pattern/currency recognizer 135 resident in the application 120 installed on the entertainment device 105. The pattern/currency recognizer 135 resident in the application 120 can determine an object associated with a given currency in the field of view of a camera of the entertainment device 105 or analyze an image of currency taken by the camera of the entertainment device 105. In this fashion, the application 120 installed on the entertainment device 105 can function in areas with little or no network connectivity. Additionally, the user can be presented with content associated with the pictured currency near instantaneously, without requiring communications with the server 115 that could be delayed due to network traffic and/or server load.

In an aspect, the pattern/currency recognizer 135 allows for determination/detection/identification of objects (e.g., a currency symbol such $, €, £, ¥, etc.) in one or more images taken by the entertainment device 105. This approach generally involves two phases: an offline phase and an online phase. The offline phase includes the creation of a dataset that contains positive images of where a specific currency (e.g., symbol or other object indicative of a type of currency) is present and negative images where the specific currency (e.g., symbol or other object indicative of a type of currency) is absent. From this dataset a classifier can then be trained, which assigns a probability that the specific currency is located at any particular sub-region in an image. The online phase can be used to localize where in the image transmitted by the entertainment device 105 (e.g., of currency) is located. In an aspect, the offline phase can be performed by the entertainment device 105 or the server 115, and the online phase can be performed by the entertainment device 105 to determine objects appearing in the camera field of view of the entertainment device 105 or appearing in an image taken with the camera of the entertainment device 105.

In an aspect, the pattern/currency recognizer 135 can identify objects in 2-dimensional images captured by a built-in camera(s) by analyzing properties of the 2-dimensional image. The pattern/currency recognizer 135 can recognize various properties of the object such as shape, color, label positioning, label text (and subsequent OCR), images present on the object, scannable codes (e.g., QR codes, bar codes, etc.), and the like.

First, object detection can be performed using a series of sliding windows to locate an object (e.g., symbol or other object indicative of a type of currency) in the image. There may be many objects present in the image, such as the user's hand and arm, other items, or multiples of the same currency (e.g., two U.S. one-dollar bills). A classifier may be trained offline from a training set that contains a variety of images of the pictured currency, at a variety of angles, and in a variety of settings (e.g., on a surface proximate to other currency types, multiples of the same currency, being held by a user, different lighting, etc.). A negative sample set that spans this variation can be included in the training set. The negative samples can be generated using randomly cropped patches that contain the same amount of structure (e.g., edges, line thickness) as the positive samples, but which do not contain the full pictured currency and/or contain other types of currency or other items.

After the dataset is created, a classifier can be trained using one or more machine learning algorithms. In this operation, first a set of features can be extracted from both the positive and negative samples in the offline phase. The extracted features can then be employed to train a classifier to distinguish the pictured currency from other currency types. The extracted features may include one or more of, for example, Fisher Vector, Histogram of Oriented Gradients (HOG), Harris corners, Local Binary Patterns (LBP), among others. The classifier trained using the extracted features can be, for example, one of the following: support vector machines (SVM), k-nearest neighbor (KNN), neural networks (NN), or convolutional neural networks (CNN), etc.

Artificial neural networks are computational tools capable of machine learning. In artificial neural networks, which will be referred to as neural networks hereinafter, interconnected computation units known as “neurons” are allowed to adapt to training data, and subsequently work together to produce predictions in a model that to some extent resembles processing in biological neural networks. Neural networks may comprise a set of layers, the first one being an input layer configured to receive an input. The input layer comprises neurons that are connected to neurons comprised in a second layer, which may be referred to as a hidden layer. Neurons of the hidden layer may be connected to a further hidden layer, or an output layer. In some neural networks, each neuron of a layer has a connection to each neuron in a following layer. Such neural networks are known as fully connected networks. The training data is used to let each connection to assume a weight that characterizes a strength of the connection. Some neural networks comprise both fully connected layers and layers that are not fully connected. Fully connected layers in a convolutional neural network may be referred to as densely connected layers. In some neural networks, signals propagate from the input layer to the output layer strictly in one way, meaning that no connections exist that propagate back toward the input layer. Such neural networks are known as feed forward neural networks. In case connections propagating back toward the input layer do exist, the neural network in question may be referred to as a recurrent neural network. Convolutional neural networks, CNN, are feed-forward neural networks that comprise layers that are not fully connected. In CNNs, neurons in a convolutional layer are connected to neurons in a subset, or neighborhood, of an earlier layer. This enables, in at least some CNNs, retaining spatial features in the input.

It can be appreciated that described above are mere examples of possible classifiers that can be adapted for use with the disclosed embodiments, and that other types of classifiers may also be employed in the context of the disclosed embodiments. That is, the disclosed embodiments are not limited to such example classifier types. In the operational phase, given an image, a series of sliding window searches can be performed using the classifier trained in the offline phase to locate potential label text and/or objects (e.g., symbol or other object indicative of a type of currency) in the image. A set of candidate windows can then be identified using a non-maximum suppression technique. The locations with the largest scores are candidates for the label text and/or objects and are examined in descending order. The window that best matched the size and aspect ratio of the label text and/or objects can be used for OCR. After OCR, the pattern/currency recognizer 135 can compare the OCR label text and/or objects to a database of text and/or objects to determine if the scanned text and/or objects matches a known currency.

In another aspect, the pattern/currency recognizer 135 can identify a 3-dimensional (3D) shape of an object in 2-dimensional images captured by a camera(s) of the entertainment device 105. In an aspect, the pattern/currency recognizer 135 may determine a 3D shape from images of objects belonging to a certain class. This 3D reconstruction can be performed by establishing a statistical shape model, denoted by the feature model, at 3D positions. Such a model is learned (e.g., the model parameters are estimated) from training data where the 2D-3D correspondence is known. This learning phase may be done using any appropriate system for obtaining such 2D-3D correspondence, including, but not limited to binocular or multi-view image acquisition systems, range scanners or similar setups. In this process, the object of interest (e.g., symbol or other object indicative of a type of currency) is measured and a reference model of the object is obtained which may be used in subsequent image analysis as will be described below.

Given an input image, the process of recovering the 3D shape is a two-step procedure. First the image features such as points, curves and contours are found in the images (e.g. using techniques such as Active Shape Models (ASM) or gradient based methods or classifiers such as SVM). Then, the 3D shape is inferred using the learned feature model. There is also the option of extending the 3D shape representation from curves and points to a full surface model by fitting a surface to the 3D data.

Generation of the feature model is described. Assume a number of elements in a d-dimensional vector t, for example, a collection of 3D points in some normalized coordinate system. The starting point for the derivation of the model is that the elements in t can be related to some latent vector u of dimension q where the relationship is linear:

t=Wu+μ (1)

where W is a matrix of size d×q and μ is a d-vector allowing for non-zero mean. Once the model parameters W and μ have been learned from examples, they are kept fixed. However, measurements take place in the images, which usually is a non-linear function of the 3D features according to the projection model for the relevant imaging device.

Denote the projection function with f: R^{d}→R^{e}, projecting all 3D features to 2D image features, for one or more images. Also, the coordinate system of the 3D features can be changed to suit the actual projection function. Denote this mapping by T: R^{d}→R^{d}. Typically, T is a similarity transformation of the world coordinate system. Thus, f(T(t)) will project all normalized 3D data to all images. Finally, a noise model needs to be specified. Assume that the image measurements are independent and normally distributed, likewise, the latent variables are assumed to be Gaussian with unit variance u˜N(0,I). Thus, in summary:

t_{2D}=f(T(t))+ϵ=f(T(Wu+μ))+ϵ (2)

where ϵ˜N(0, σ² I) for some scalar σ.

Before the model can be used, its parameters need to be estimated from training data. Given that it is a probabilistic model, this is can be done with maximum likelihood (ML). Assume n examples {t_{2D,i}}ᵢ₌₁ⁿ, the ML estimate for W and μ is obtained by minimizing:

Σᵢ₌₁ⁿ(1/σ²∥t_{2D}−f(Tᵢ(uᵢ))∥²+∥uᵢ∥² (3)

over all unknowns. The standard deviation a is estimated a priori from the data. Once the model parameters W and μ have been learned from examples, they are kept fixed. In practice, to minimize (3) the methods can alternatively optimize over (W, μ) and {uᵢ}ᵢ₌ᵢⁿ using gradient descent. Initial estimates can be obtained by intersecting 3D structure from each set of images and then applying PPCA algorithms for the linear part. The normalization Tᵢ(.) is chosen such that each normalized 3D sample has zero mean and unit variance.

There are three different types of geometric features embedded in the model, points, curves, and apparent contours. Points: A 3D point which is visible in m>1 images will be represented in the vector t with its 3D coordinates (X,Y,Z). For points visible in only one image, m=1, no depth information is available, and such points are represented similarly to apparent contour points. Curves: A curve will be represented in the model by a number of points along the curve. In the training of the model, it is important to parameterize each 3D curve such that each point on the curve approximately corresponds to the same point on the corresponding curve in the other examples. Apparent contours: As for curves, we sample the apparent contours (in the images). However, there is no 3D information available for the apparent contours as they are view-dependent. A simple way is to treat points of the apparent contours as 3D points with a constant, approximate (but crude) depth estimate.

### Finding Image Features

In the on-line event of a new input sample, the latent variables u and can be determined and, in turn, estimates of the 3D features t can be computed. The missing component in the model is the relationship between 2D image features and the underlying grey-level (or color) values at these pixels. There are several ways of solving this, such as by using an ASM (denoted the grey-level model) or detector based approaches.

### The Grey-Level Model

Using the same notation as in (1) (e.g., a linear model (PPCA)), but now with the subscript gl for grey-level, the model can be written:

t_{gl}=W_{gl}u_{gl}+μ_{gl}+ϵ_{gl} (4)

where t_{gl} is a vector containing the grey-level values of all the 2D image features and ϵ_{gl} is Gaussian noise in the measurements. In the training phase, each data sample of grey-levels is normalized by subtracting the mean and scaling to unit variance. The ML-estimate of W_{gl} and μ_{gl} is computed with the EM-algorithm [5].

### Detector-Based Methods

Image interest points and curves can be found by analyzing the image gradient using e.g. the Harris corner-detector. Also, specially designed filters can be used as detectors for image features. By designing the filters so that the response for certain local image structures are high, image features can be found using a 2D convolution.

### Classification Methods

Using classifiers such as SVM, image regions can be classified as corresponding to a certain feature or not. By combining a series of such classifiers, one for each image feature (points, curves, contours etc.) and scanning the image at all appropriate scales the image features can be extracted. Examples can be e.g. an eye detector for facial images.

### Deformable Models

Using a deformable model such as the Active Contour Models, also called snakes, of a certain image feature is very common in the field of image segmentation. Usually the features are curves. The process is iterative and tries to optimize an energy function. An initial curve is deformed gradually to the best fit according to an energy function that may contain terms regulating the smoothness of the fit as well as other properties of the curve.

### Surface Fitting to the 3D Data

Once the 3D data is recovered, a surface model can be fitted to the 3D structure. This might be desirable in case the two-step procedure above only produces a sparse set of features in 3D space such as e.g. points and space curves. Even if these cues are characteristic for a particular sample (or individual), it is often not enough to infer a complete surface model, and in particular, this is difficult in the regions where the features are sparse. Therefore, a 3D surface model consisting of the complete mean surface is introduced. This will serve as a domain-specific, e.g., specific for a certain class of objects, regularizer. This approach requires that there is dense 3D shape information available for some training examples in the training data of the object class obtained from images captured by the entertainment device 105 and/or stored at the server 115. From these dense 3D shapes, a model can be built separate from the feature model above. This means that, given recovered 3D shape, in the form of points and curves, from the feature model, the best dense shape according to the recovered 3D shape can be computed. This dense shape information can be used to improve surface fitting.

To illustrate with an example, consider the case of the object class being currency symbols. The model is then learned using points, curves, and contours in images together with the true 3D shape corresponding to these features obtained from multi-view stereo techniques. A second model is then created and learned using, for example, laser scans of currencies, giving a set of currency surfaces. This second model can be used to find the most probable, or at least highly probable, mean currency surface (e.g., according to the second model) corresponding to the features or the recovered 3D shape. A surface can then be fitted to the 3D shape with the additional condition that where there is no recovered 3D shape, the surface should resemble the most probable mean bottle surface. The methods described above provide the most probable or an at least highly probable 3D shape.

FIG. 2 is a flowchart of one embodiment of a process 200 to present a user with a description of content that is associated with a country from which a detected currency is issued. The process 200 will be described by reference to FIG. 1. For example, the process 200 may be performed by the application 120, which is running on the entertainment device 105. In particular, the process 200 may be performed by pattern/currency recognizer 135 and/or decision maker 140 of the application 120. The process 200 presents notifications referring to descriptions of content (e.g., any type of audio-visual content, such as music, movies, or games) of artists (e.g., singers) where the content is associated with several countries, through currency recognition. In one embodiment, the application 120 may be associated with any theme in which content purchases are possible. It should be understood that process 200 may be performed once a user of the entertainment device 105 has downloaded, installed, and registered (e.g., with a service provider of the application) the application 120. As previously described, the application 120 may be a free application that the user of the entertainment device 105 may retrieve from the service provider.

In FIG. 2, process 200 begins by initiating the application (e.g., 120) by launching (or opening) the application e.g., through a tap gesture on a graphical user interface (GUI) item displayed on the display screen 107 of the entertainment device 105 (at block 205). This initiation may be the first time in which the user opens the application (e.g., after it is downloaded and installed), in which case, the user may be required to register with the service provider, as previously described. In one embodiment, however, the initiation may be any time after the user has registered with the service provider. With the application 120 open, the process 200 captures an image of currency, either being coinage or paper money, issued by a country or a government body of the country (e.g., at block 210). For example, as previously described, the user may take a United States one-dollar bill (e.g., out of a wallet) and, with the dollar bill in hand, may “aim” the device's built-in digital camera at the bill (or a portion of the bill) and have the camera capture an image (e.g., picture) of the bill. In one embodiment, rather than capturing an image of paper money, the user may perform this operation using coinage, such as a United States quarter dollar.

The process 200 analyzes the captured image to detect the currency in the image (e.g., at block 215). This analysis may be performed by the pattern/currency recognizer 135, which may analyze shapes within the image and their dimensions (with respect to each shape and one another) to identify structural patterns. For instance, if the image is of a United States one-dollar bill, the pattern/currency recognizer 135 may identify a structural pattern relating to the portrait of George Washington featured on the obverse of the bill. Along with identifying particular patterns, such as the portrait, the pattern/currency recognizer 135 may recognize patterns of the entire obverse and/or reverse of the dollar bill. The pattern/currency recognizer 135 compares the identified structural pattern with the predefined structural patterns associated with different currencies that are stored within the data structure 125 to determine which of the predefined structural patterns matches the identified structural pattern. For instance, the pattern/currency recognizer 135 may consider a “match” based on a percentage in which a predefined structural pattern is similar in structure to that of the identified structural pattern. For example, a match may be a predefined structural pattern that is 90% (or above) similar to that of the identified structural pattern. Determining whether the identified structural pattern matches the predefined structural pattern may be accomplished by the application 120 and/or the server 115.

Once a matching predefined structural pattern is found, indicating that the application has detected the currency in the digital image, the process 200 performs a table lookup using the detected currency, into the data structure 125 (e.g., at block 220). The data structure 125 associates each currency with a description of associated content that is associated with the country from which the detected currency is issued. The content is for distribution through the associated country. To perform the table lookup, the decision maker 140 may use the detected currency (e.g., a United States one-dollar bill) as an input to retrieve descriptions of content associated with the detected currency. The process 200 determines whether there are one or more entries (e.g., matching descriptions) in the table that are associated with the detected currency (e.g., at decision block 230). For example, associated descriptions of content may be of content that are distributed through or within the country (e.g., the United States) that issued the detected currency. In one embodiment, different denominations of currency (e.g., a United States five-dollar bill versus a United States one-dollar bill) may have different (or similar) matching descriptions of content. In this way, the service provider may categorize content available for purchase based on the denominations (e.g., more expensive content may be associated with higher denominations of currency than less expensive content.)

If there are matching descriptions of content associated with the detected currency, the process 200 selects one or more descriptions of content for the matching entry (e.g., at block 235). In one embodiment, the process 200 may select all matching descriptions of content that are associated with the detected currency. In one embodiment, the decision maker 140 may narrow down potential descriptions of content for selection based on additional descriptive information, as described above. In one embodiment, if after narrowing down the potential descriptions of content there remain several descriptions to choose from, the decision maker 140 may select them all. In another embodiment, the decision maker 140 may select one (or a subset) of the descriptions either randomly or based on other criteria, separate from that defined by the user (or the application), such as average popularity of the content of the description. In one embodiment, if there is only one matching description of content, the decision maker 140 selects that one description of content.

In one embodiment, if a matching description of content is associated with several versions of a same content (e.g., different languages and/or formats of the same content), the decision maker 140 may decide which version of content the description will refer to, based on user input. For example, a piece of content (e.g., movie) may be distributed in a country (e.g., the United States), which has a diverse population, speaking several different languages. As a result, content providers may distribute different versions of content, each version being of a different language. For instance, in the case of a movie, which originally is distributed in the United States in English, a content provider may also distribute a dubbed version (e.g., in Spanish) for people who are proficient in another language. Thus, in one embodiment, when a matching description is associated with several versions of a same content, the decision maker 140 may identify the several versions of the content associated with the description and prompt the user to select a particular language the user wishes the matching description to refer to. In other words, the application program 120 may present several GUI options (e.g., each associated with a particular language—such as English and Spanish) on the display screen 107 for selection by the user. In one embodiment, rather than prompt the user, the decision maker 140 may retrieve a previously defined user setting within the application 120, which identifies what language the user wishes to retrieve content to be in. Once the user selects the particular language (e.g., English), the decision maker 140 may associate the selected description with the version of the content having the particular language.

In another embodiment, the decision maker 140 may base its selection on an identified language when the detected currency is associated with several countries. For example, in the case of the Euro, which is the official currency of the Eurozone, comprising 19 member states (e.g., countries) of the European Union, there may be several different types and/or versions of content described by matching descriptions (e.g., different languages). Thus, the decision maker 140 may retrieve the previously user-defined language and select descriptions of content having (e.g., being in) that particular language.

With a selected one of the descriptions of content, the process 200 presents the user with a notification (e.g., a pop-up) referring to the description of content displayed on the display screen 107 of the entertainment device (e.g., at block 240). The presented notification may refer to the description by including the description (e.g., text and a thumbnail image) of the content and a price (e.g., $0.99) to purchase (or license) the content, if the content has yet to be purchased. In one embodiment, if several versions of the content were identified, and one particular version selected (e.g., based on user input), the notification may also refer to the selected version of the content (e.g., indicating that the content is in English or an English version of the content.) Before presenting the notification, a short (e.g., thirty second) introductory video (or advertisement) may be played back to the user on the display screen 107 of the entertainment device 105. In one embodiment, if several descriptions of content are selected, each of the descriptions may be presented in a separate notification within a scrollable list, displayed on the display screen of the entertainment device 105. This allows the user to scroll through the notifications, in order to decide which (if any) should be accessed. If the user wishes to access the content, the user may simply select (e.g., through a tap gesture) on the notification. If the content is immediately available for access (e.g., either because it is free or because the user already has access to the content—through an earlier purchase), the content is presented to the user. Otherwise, if the content must be purchased before the user is allowed to gain access, the application 120 may perform an “in-app” purchase of the content. The entertainment device 105 may send a request (e.g., with a code or content identifier that identifies the content from the storage structure 125, a confirmation of the purchase, a unique identifier of the entertainment device 105, and/or an application identifier) to the server 115. This may include sending a message that requests an account of the user to be charged in an amount indicated in the notification (e.g., a cost for the particular content.). In one embodiment, once selected, the application 120 may automatically perform the in-app purchase through a third party provider payment service, which may then transmit confirmation of the purchase to the server 115. Once the server 115 receives confirmation of the purchase and the code, it retrieves the content from the storage 130 and compresses and encrypts the content with an encryption key. The server 115 then forwards the encrypted content to the entertainment device 105, along with the encryption key. In one embodiment, the encryption key may be transferred at a later time (e.g., via a separate transmission). The entertainment device 105 may then store the encrypted content within the application 120 (e.g., within the storage structure 145) and the encryption key in memory. The entertainment device 105 may then decrypt (and decompress) the content, for presentation to the user. In one embodiment, rather than retrieving content from the server 115, the application 120 may retrieve an encryption key (and content identifier) for use in gaining access to encrypted content already stored within a content storage 145 within the application 120. More about encryption keys and gaining access to encrypted content is described in FIGS. 3-4.

In one embodiment, the entertainment device 105 may begin to download the content (e.g., from the server 115) even before the server 115 confirms the purchase. For example, once the user selects the notification to purchase the content, the application 120 may immediately begin to download an encrypted version of the content, for storage in the optional content storage 145. In one embodiment, the content may also be compressed, as previously described. Once the server 115 receives confirmation of the purchase (e.g., from the entertainment device and/or the service provider), it may transmit the encryption key (and content identifier) for use in gaining access to the encrypted content. In this way, the user does not have to wait for the content after making the purchase, but rather can access the content immediately thereafter.

In one embodiment, the application presents the content by displaying the video of the content in the display screen 107 and outputting audio through built-in speakers and/or a headphone jack of the entertainment device 105. If, however, the notification is selectable to purchase a product (e.g., clothes, tools, or electronics), once the server 115 receives confirmation of the purchase, the server 115 may transmit a sales confirmation to a distributor of the product, along with a mailing address of the user, in order for the distributor to mail the product to the user. In one embodiment, rather than automatically performing the in-app purchase, the entertainment device 105 may navigate to a graphical user interface screen for purchasing the content. In one embodiment, the application 120 may navigate to a website owned by the service provider to complete the purchase process (e.g., an e-commerce website), in response to receiving a request by the user (e.g., a selection of the pop-up) to purchase the content.

If, however, there are no matching descriptions of content that are associated with the country from which the detected currency is issued, the process 200 prompts the user with a notification (e.g., pop-up on the entertainment device 105), indicating that there was not a match (e.g., at block 245). Such a notification may simply say “No Content Found.” While, in another embodiment, when there is not a match, the user may still be prompted with a notification (e.g., pop-up on the entertainment device 105) for user selection to access other content. For example, the application may present the user with a notification that refers to a description of content that is “commonly purchased” content relating to, for example, a theme of the application 120 or that is commonly purchased by other users of the application 120. In one embodiment, the application 120 may present descriptions of content in which the application 120 believes the user may want (e.g., based on previous purchases of similar/related content). The process 200 determines whether another image has been taken by the entertainment device 105 (e.g., at block 250). If another image has been taken, the process 200 proceeds back to block 215, otherwise, the process 200 ends.

Since the application 120 described above is performing all of the operations described in process 200, any delay associated with accessing an image pattern recognizer that may otherwise be running on a remote server in the Internet is avoided. Moreover, any delay associated with accessing a decision maker as to which description of content should be presented for a particular recognition event is also avoided, thereby making the presentation to the user of the description of content essentially immediately after the user aimed the device at the currency (e.g., in order to capture an image with the built-in camera).

Some embodiments perform variations of the process 200. The specific operations may not be performed in one continuous series of operations, and different specific operations may be performed in different embodiments. For example, in one embodiment, if a matching predefined structural pattern is not found at block 215 (e.g., meaning that the image does not contain a known currency issued by any country in the lookup table), the process 200 may prompt the user to take another picture (e.g., with the entertainment device 105). In another embodiment, the user may be prompted with a notification (e.g., at the entertainment device 105) indicating that no currency is detected in the image, at which point the process 200 may end. In one embodiment, the operations performed to select the matching description of content (e.g., at block 235) may be performed by the decision maker 140 at block 220. In other words, the decision maker 140 may perform the table lookup using several inputs, such as the detected currency and a theme of the application 120 (e.g., a music genre of jazz), to just name a few, in order to narrow down potential descriptions of content as the table lookup is being performed.

FIG. 3 is a flowchart of one embodiment of a process 300 to receive encryption keys for use in gaining access to purchased content stored within the content storage 145 of the application 120. The process 300 will be described by reference to FIGS. 1-2. For example, the process 300 may be performed by the application 120, which is running on the entertainment device 105. The process 300 begins by establishing a secure (e.g., Secure Sockets Layer (SSL)) connection, via the Internet 110, with the remote server 115 (at block 305). For instance, the application 120 may initiate an SSL handshake with an authentication interface of the server 115 to produce cryptographic parameters. For example, the server 115 may configure its portal and command line to establish the SSL connection. The server 115 may then generate and present a digital certificate to authenticate itself to the application 120. Once the server 115 has been authenticated, the application 120 and the server 115 may establish a shared key (e.g., a PGP key, shared encryption key, blockchain, etc.) to encrypt data exchanged during the remainder of the connection session.

With an established SSL connection, the process 300 securely transmits a unique identifier of the entertainment device 105 (e.g., a device serial number or a MAC address) and an application identifier (at block 310). In one embodiment, the service provider may assign the application identifier to the application 120, once the application 120 is registered with the service provider of the application 120. The server 115 uses both identifiers to retrieve content identifiers (e.g., codes) that each identify encrypted content (e.g., audio-visual specially licensed content) purchased by the user of the entertainment device 105, through the application 120 (e.g., as described in FIG. 2), and an encryption key for use in accessing the identified encrypted content. For example, the server may keep track of purchased (e.g., encrypted) content in a data structure (e.g., lookup table) that associates the unique identifier and the application identifier with content identifiers of encrypted content purchased by the user through the application and encryption keys used to encrypt the content. In one embodiment, the server 115 may only use one of the two identifiers. Thus, when the identifiers are received, the server 115 performs a table lookup to identify the content identifiers and encryption keys.

The process 300 receives the encryption keys and content identifiers based on the unique identifier and/or application identifier, through the SSL connection, and stores the encryption keys and content identifiers in (e.g., a data structure) memory of the entertainment device 105 (e.g., at block 315). In one embodiment, the encryption keys and content identifiers may be stored in physical and/or temporary memory (e.g., Random Access Memory). As a result, once the application 120 is closed (e.g., a programmed processor executing the application 120 ceases to execute the application) or the entertainment device 105 is turned off, the encryption keys and content identifiers may be erased from and/or no longer held in the memory. Thus, by preventing the encryption keys and/or content identifiers from being permanently stored within the application 120 (e.g., in memory of the entertainment device 105), there is a less likelihood that a user may nefariously gain access to encryption keys for unauthorized distribution and/or access. In one embodiment, rather than erasing the encryption keys and content identifiers, they may be securely stored in a structure within the application 120, for later use to access encrypted content within the content storage 145. As a result to storing the encryption keys and content identifiers, a user may gain access to the encrypted content, in instances in which a secure connection may not be established (e.g., because the entertainment device 105 is not within range of a wireless communications network).

In one embodiment, since the encryption keys and content identifiers may be erased when the application 120 is closed, the process 300 may be performed during initialization of the application, as described in block 205 of FIG. 2. For example, each time the user launches the application 120 (e.g., through a tap gesture of the GUI item displayed on the display screen 107), the application 120 may retrieve encryption keys and content identifiers corresponding to purchased encrypted content, as described in blocks 305-315 above. In another embodiment, the application 120 may perform this process each time content is purchased by the user (e.g., as described in FIG. 2), to retrieve encryption keys for accessing purchased encrypted content (e.g., stored in content storage 145). As a result, when new content is purchased, the server 115 may update the lookup table indicating what content has been purchased, in order to subsequently send an updated list of encryption keys and content identifiers the next time the process 300 is performed.

Some embodiments perform variations of the process 300. The specific operations may not be performed in one continuous series of operations, and different specific operations may be performed in different embodiments. For example, in one embodiment, if the transmitted unique identifier of the entertainment device and/or the application identifier are not associated with purchased content (e.g., the user has yet to purchase content), nothing may be received from the server. In another embodiment, the server may instead transmit a message indicating to the application 120 that the identifiers are not associated with purchased content. In one embodiment, once the encryption keys and content identifiers have been received, as described in block 315, the application 120 may end the established SSL connection with the server 115.

FIG. 4 is a flowchart of one embodiment of a process 400 to gain access to content (e.g., stored within the content storage 145 of the application 120.) The process 400 will be described by reference to FIGS. 1-3. For example, the process 500 may be performed by the application 120, which is running on the entertainment device 105. The process 500 begins by determining whether a request to access content is received. For example, the request may be a result of the user selecting the notification (e.g., through a tap gesture, as described in block 240 of FIG. 2). The process 400 determines whether the content described in the selected notification is encrypted (e.g., at decision block 410). If the content is not encrypted, the user is able to gain access without having to purchase the content beforehand (e.g., in order to retrieve encryption keys from the server, as described in FIG. 3). Specifically, the application will read (e.g., analyze) the header of the content, which identifies whether the content is encrypted or not. If the content is unencrypted, the application 120 will allow the user to gain access to the content (e.g., if the content is audio-visual, the application 120 will playback the content at block 415.)

If, however, the content is encrypted (based on the analysis of the content header), process 400 determines whether any encryption keys were received during the initialization of the application, as described in FIG. 3 (e.g., at decision block 420.) If no encryption keys were received (e.g., because the user has yet to purchase any content), the process 400 displays a prompt (e.g., at the entertainment device 105) that indicates that content has yet to be purchased (e.g., at block 425). For example, the application 120 may display a GUI item (e.g., a red padlock) indicating that the application may not gain access to the content. At this point, the application may prompt (e.g., with a notification at the entertainment device 105) the user to purchase the content (e.g., through an in-app purchase), if the user wishes to gain access.

If, however, encryption keys and content identifiers were received during initialization, the process 400 determines whether any of the received encryption keys are for decrypting the content. For example, the application 120 may determine whether any of the encryption keys are for decrypting content. If none are, meaning that the user has purchased content other than the one the user is currently attempting to gain access, the process 400 proceeds to display a prompt (e.g., at the entertainment device 105) that indicates the content has not yet been purchased (e.g., at block 425). For example, the application 120 may display another GUI item (e.g., a green padlock) indicating that the application may gain access to other content, besides the one selected. In one embodiment, the application may prompt the user to purchase the content, as described in block 425.

If, however, the received encryption keys are for decrypting the content, the process 400 validates the content (e.g., a header of the content) by confirming that the content identifier identifies the content, decrypts the content using the encryption key associated with the content identifier, and accesses the content (e.g., at block 435). In one embodiment, if the content is unable to be validated, the process 400 may display a prompt (e.g., a red “X” at the entertainment device 105) indicating that the content is not valid. If the content is not valid, the user may be prompted to either download the content again or to purchase the content again.

Some embodiments perform variations of the process 400. The specific operations may not be performed in one continuous series of operations, and different specific operations may be performed in different embodiments.

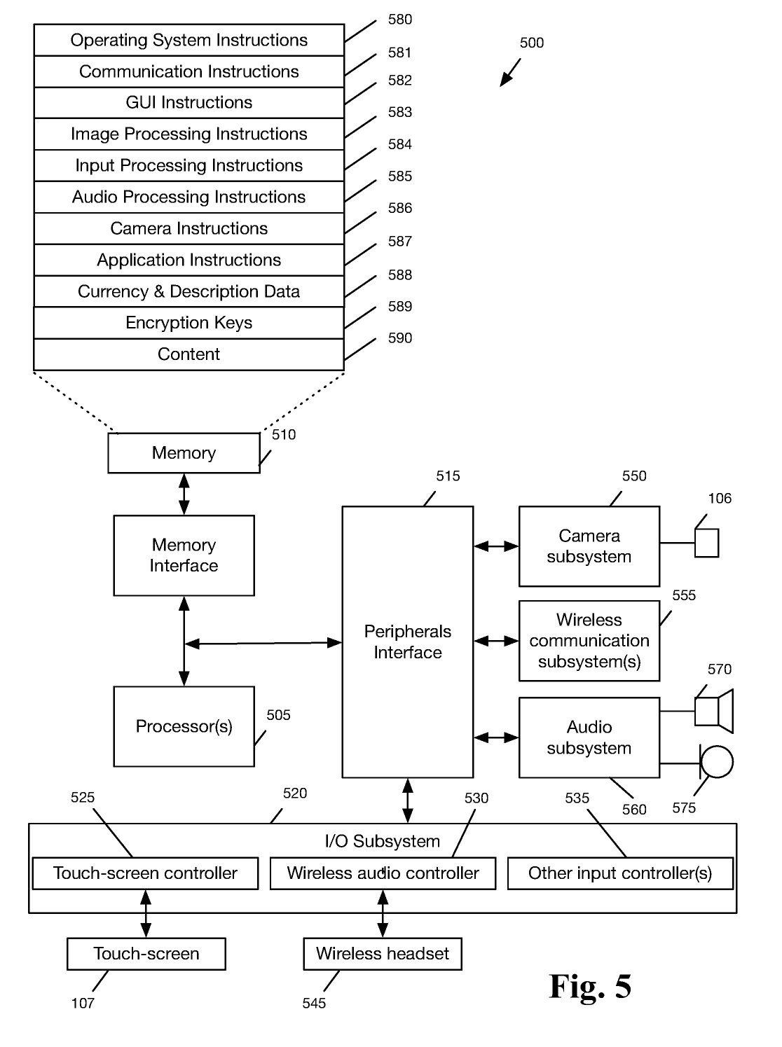

The applications of some embodiments operate on computing entertainment systems (e.g., devices), such as smartphones, tablet computers, laptop computers, desktop computers, etc. FIG. 5 is an example of an architecture 500 of such a computing entertainment system. As shown, the computing system 500 includes one or more processing units (e.g., processors) 505, a memory interface 590 and a peripherals interface 515.

The peripherals interface 515 may be coupled to various sensors and subsystems, including a camera subsystem 550, a wireless communication subsystem(s) 555, an audio subsystem 560, an I/O subsystem 520, etc. The peripherals interface 515 may enable communication between the processing units 505 and various peripherals.

The camera subsystem 550 may be coupled to one or more cameras 106, each with an optical sensor(s) (e.g., a charged coupled device (CCD) optical sensor, a complementary metal-oxide-semiconductor (CMOS) optical sensor, etc.). The camera subsystem 550, coupled with the optical sensor(s) of the cameras 106, facilitates camera functions, such as image and/or video data capturing. The wireless communication subsystem 555 serves to facilitate communication functions. In some embodiments, the wireless communication subsystem 555 includes radio frequency receivers and transmitters (e.g., AM/FM) and optical receivers and transmitters (not shown in FIG. 5). These receivers and transmitters of some embodiments are implemented to operate over one or more communication networks (e.g., wireless networks) such as a CDMA network, GSM network, a Wi-Fi network, a Bluetooth network, etc. The audio subsystem 560 is coupled to a speaker 570 to output audio (e.g., to output sound). Additionally, the audio subsystem 560 may be coupled to a microphone 575 to facilitate voice-enabled functions, such as voice recognition (e.g., for searching), digital recording, etc.

The I/O subsystem 520 involves the transfer between input/output peripheral devices, such as a display, a touch screen, etc., and the data bus of the processing units 505 through the peripherals interface 515. The I/O subsystem 520 includes a touch-screen controller 525, a wireless audio controller 530, and other input controllers 535 to facilitate the transfer between input/output peripheral devices and the data bus of the processing units 505. As shown, the touch-screen controller 525 is coupled to a touch-sensitive display screen 107. The touch-screen controller 525 detects contact and movement on the touch screen 107 using any of multiple touch sensitivity technologies. The wireless audio controller 530 is wirelessly coupled to a wireless headset 545 (e.g., a Bluetooth™ headset or head phone(s)) that may be used to receive and transmit audio signals (e.g., during an audio call). The other input controllers 535 are coupled to other input/control devices, such as one or more buttons. Some embodiments include a near-touch sensitive screen and a corresponding controller that can detect near-touch interactions instead of or in addition to touch interactions.

The memory interface 590 is coupled to memory 510. In some embodiments, the memory 510 includes volatile memory (e.g., high-speed random access memory), non-volatile memory (e.g., flash memory), a combination of volatile and non-volatile memory, and/or any other type of memory. As illustrated in FIG. 5, the memory 510 stores an operating system (OS) 580. The OS 580 includes instructions for handling basic system services and for performing hardware dependent tasks.

The memory 510 also includes communication instructions 581 to facilitate communicating with one or more additional devices; graphical user interface (GUI) instructions 582 to facilitate graphic user interface processing; image processing instructions 583 to facilitate image-related processing and functions; input processing instructions 584 to facilitate input-related (e.g., touch input) processes and functions; audio processing instructions 585 to facilitate audio-related processes and functions; camera instructions 586 to facilitate camera-related processes and functions; application instructions 587 to facilitate the presentation of (e.g., specially licensed) content once a currency issued by a country associated with the content is detected; currency and content description data 588 that includes (e.g., predefined structural patterns of) several different currencies and associated descriptions of content that are associated with the several different countries from which the currencies are issued, by being distributed through and/or within the several different countries; encryption keys 589 (e.g., which are stored while the application is executing) that are received from the service provider during initialization of the application and/or when content is purchased; and optional (e.g., audio-visual) content 590. The instructions described above are merely exemplary and the memory 510 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 5 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 5 may be split into two or more integrated circuits.

As previously explained, an embodiment of the invention may be a non-transitory machine-readable medium (e.g., such as microelectronic memory) having stored thereon instructions, which program one or more data processing components (e.g., generically referred to here as a “processor”) to perform the image processing operations (e.g., currency recognition), capturing images, analyzing the captured images to detect currency within, performing a table lookup using the detected currency into a data structure stored within memory of the entertainment device that associates currencies with descriptions of content that are associated with countries from which the currencies are issued, by being distributed through and/or within the different countries, narrowing down potential descriptions of content for selection, selecting a description of content that is associated with a country that issued the detected currency, presenting a notification that refers to the selected description of content, and retrieving purchased specially licensed content. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

For example, any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method performed by a programmed processor in an entertainment device that is executing an application program stored in the device, the method comprising:
performing a digital image processing currency recognition algorithm upon an image that has been captured by a digital camera in the entertainment device, to indicate a detected currency, wherein the algorithm is configured to detect a plurality of different currencies from digital images of coinage or paper money of the different currencies;
performing a table lookup using the detected currency, into a data structure stored in the entertainment device, wherein the data structure associates the plurality of different currencies with a plurality of descriptions of content, respectively, wherein each content is distributed through a country from which the associated currency is issued; and
upon selecting one of the plurality of descriptions of content, requesting that a notification which refers to the selected description be presented for display through a touch screen of the entertainment device.

2. The method of claim 1 further comprising receiving a selection in the notification, through the touch screen and in response
retrieving the content described in the selected description from a memory of the entertainment device; and
requesting that the content be presented for display on the touch screen of the device.

3. The method of claim 2 further comprising
periodically receiving new content that is distributed through the plurality of different countries from which associated currencies are issued, respectively, and descriptions of the new content from a remote server; and
adding the 1) new content into memory of the entertainment device and 2) descriptions of the new content into the data structure, wherein when a table lookup is performed using a same detected currency, selecting a description of new content that is distributed through the country from which the detected currency was issued.

4. The method of claim 2, wherein the retrieved content is encrypted content, wherein the method further comprises
establishing a secure connection, via a network, between the application program and a remote server to transmit, through the secure connection, a unique identifier of the entertainment device and an application identifier of the application program to the remote server; and
receiving an encryption key associated with the unique identifier and the application identifier for decrypting the encrypted content, prior to its presentation.

5. The method of claim 4 further comprising storing the encryption keys in temporary memory that does not hold the encryption keys, once the application program ceases to be executed by the programmed processor, wherein each time the application program is executed by the program processor, the operations of establishing a secure connection and receiving the encryption key are performed.

6. The method of claim 1, wherein the selected description comprises a textual description of the content, and a content identifier or code that references the content which is stored in a remote server.

7. The method of claim 6 further comprising receiving a selection in the notification, through the touch screen and in response:
sending a message to a remote server to charge an account of a user of the device a purchase price, listed in the description of the content of the artist, wherein the message includes the content identifier or code that references the content; and
receiving the content and then presenting the content in the device.

8. The method of claim 1, wherein the content described in the selected description is distributed through a particular country from which the detected currency is issued, wherein selecting the one of the plurality of descriptions of content comprises
matching the one of the plurality of descriptions of content with the detected currency, based on the performed table lookup;
identifying a plurality of versions of the content associated with the description, wherein each version is of a different language; and
selecting one of the plurality of versions of content based on a user input, wherein the notification further refers to the selected one of the plurality of versions of content.

9. The method of claim 1, wherein the content described by the selected description comprises specially licensed content that is textual, graphical, musical, or an audio-visual licensed work of an artist.

10. The method of claim 1, wherein the content described in the selected description is distributed through a particular country from which the detected currency is issued, and wherein the method further comprises, based on the performed table lookup, narrowing down potential descriptions of content that are associated with the detected currency for selection using additional data stored within memory of the entertainment device.

11. The method of claim 10, wherein the additional data is one of i) user settings of the entertainment device, and ii) content purchase history of the application program.

12. A computing entertainment system comprising:
a processor; and
memory having stored therein an application program comprising instructions that when executed by the processor
perform a digital image processing currency recognition algorithm upon an image that has been captured by a digital camera of the computing entertainment system, to indicate a detected currency, wherein the algorithm is configured to detect a plurality of different currencies from digital images of coinage or paper money of the different currencies;
perform a table lookup using the detected currency, into a data structure that is stored in memory, wherein the data structure associates the plurality of different currencies with a plurality of descriptions of content, respectively, wherein each content is distributed through a country from which the associated currency is issued; and
upon selecting one of the plurality of descriptions of content, request that a notification which refers to the selected description be presented for display through a touch screen of the computing entertainment system.

13. The computing entertainment system of claim 12, wherein in response to receiving a selection in the notification, through the touch screen, the memory comprises further instructions that when executed by the processor
retrieve the content described in the selected description from the memory of the computing entertainment system; and
request that the content be presented for display on the touch screen of the computing entertainment system.

14. The computing entertainment system of claim 13, wherein the memory comprises further instructions that when executed by the processor
periodically receive new content that is distributed through the plurality of different countries from which the associated currencies are issued, by being distributed through the plurality of different countries, respectively, and descriptions of the new content from a remote server; and
add the 1) new content into memory of the computing entertainment system and 2) descriptions of the new content into the data structure, wherein when a table lookup is performed using a same detected currency, selecting a description of new content that is distributed through the country from which the detected currency was issued.

15. The computing entertainment system of claim 13, wherein the retrieved content is encrypted content, the memory comprises further instructions that when executed by the processor
establish a secure connection, via a network, between the computing entertainment system and a remote server to transmit, through the secure connection, a unique identifier of the computing entertainment system and an application identifier of the application program to the remote server; and
receive an encryption key associated with the unique identifier and the application identifier for decrypting the encrypted content, prior to its presentation.

16. The computing entertainment system of claim 15 further comprising storing the encryption keys in temporary memory that does not hold the encryption keys, once instructions ceases to be executed by the processor, wherein each time the instructions are executed by the program processor, the operations of establishing a secure connection and receiving the encryption key are performed.

17. The computing entertainment system of claim 12, wherein the selected description comprises a textual description of the content, and a content identifier or code that references the content which is stored in a remote server.

18. The computing entertainment system of claim 17, wherein in response to receiving a selection in the notification, through the touch screen, the memory comprises further instructions that when executed by the processor
send a message to a remote server to charge an account of a user of the computing entertainment system a purchase price, listed in the description of the content, wherein the message includes the content identifier or code that references the content of the artist; and
receive the content and then present the content of the artist in the computing entertainment system.

19. The computing entertainment system of claim 12, wherein the content described in the selected description is distributed through a particular country from which the detected currency is issued, wherein the instructions to select one of the plurality of descriptions of content comprises instructions that when executed by the processor
match the one of the plurality of descriptions of content with the detected currency, based on the performed table lookup;
identify a plurality of versions of the content associated with the description, wherein each version is one of a different language; and
select one of the plurality of versions of content based on a user input, wherein the notification further refers to the selected one of the versions of content.

20. The computing entertainment system of claim 12, wherein the content described by the selected description comprises specially licensed content that is textual, graphical, musical, or an audio-visual licensed work of an artist.

21. The computing entertainment system of claim 12, wherein the content described in the selected description is distributed through a particular country from which the detected currency is issued, and wherein the memory comprises further instructions that when executed by the processor, based on the performed table lookup, narrow down potential descriptions of content that are associated with the detected currency for selection using additional data stored within memory of the entertainment device.

22. The computing entertainment system of claim 21, wherein the additional data is one of i) user settings of the entertainment device, and ii) content purchase history of the application program.
